(19) United States
(12) Patent Application Publication
(10) Pub. No.: US 2006/0209025 A1
(43) Pub. Date: Sep. 21, 2006

(54) Wireless mouse

(75) Inventors: Yu-Chih Cheng, Taipei (TW); Bin-Hui Huang, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/104,226

(22) Filed: Apr. 12, 2005

(30) Foreign Application Priority Data
Mar. 17, 2005 (TW) 94108140

(51) Int. Cl. G09G 5/08

(52) U.S. Cl. 345/163

(57) ABSTRACT

A wireless mouse includes a mouse main body, a wireless signal receiver and a storage device. The storage device is pivotally coupled to the mouse main body. In response to an elastic force resulting from a resilience element, a storage part of the storage device is easily exposed from the inside of the mouse main body so as to remove/store the wireless signal receiver from/into the storage device.

### FIELD OF THE INVENTION

The present invention relates to a wireless mouse, and more particularly to a wireless device whose wireless receiver can be stored within the main body thereof.

### BACKGROUND OF THE INVENTION

With increasing development of the computer industries, wireless transmission technologies are widely used for signal transmission. As known, many wireless transmission specifications such as IrDA, Bluetooth or the like are employed.

In addition, many wireless peripheral devices are developed to use in the computer system. Examples of the peripheral devices include wireless mice, wireless earphones, wireless keyboards, and so on. Among these, the wireless mice are the most popular wireless peripheral devices of the computer system.

Although the wireless mouse is convenient because no connecting wire is required, there are still several drawbacks. For example, when the wireless mouse is operated, a corresponding wireless signal receiver is necessary. In a case that this wireless mouse is used in other places, the corresponding wireless signal receiver should be also carried. In other words, if the wireless mouse and the wireless signal receiver are separately stored, the user may lose either the wireless mouse or the wireless signal receiver. Under such circumstance, the wireless mouse fails to be normally operated.

### SUMMARY OF THE INVENTION

It is an object of the present invention to provide a wireless mouse having a storage device for storing the wireless signal receiver.

In accordance with an aspect of the present invention, there is provided a wireless mouse. The wireless mouse comprises a mouse main body, a wireless signal receiver and a storage device. The mouse main body is used for generating a pointing signal to control a pointer of a computer. The wireless signal receiver is in communication with the computer for receiving the pointing signal and transmitting the pointing signal to the computer. The storage device is disposed within the mouse main body for storing the wireless signal receiver, and comprises a storage body and a resilience element. The storage body comprises a storage part for containing the wireless signal receiver, a first connecting part for allowing the storage body to be pivotally coupled to the mouse main body, and a sliding sheet moving relative to the storage part and having a fastening element for allowing the storage body to be engaged within the mouse main body therevia when the storage device is in a first usage status. The resilience element is disposed on the first connecting part for providing an elastic force to the storage body such that the storage body is disengaged from inside of the mouse main body when the storage device is in a second usage status.

Preferably, the resilience element is a torsion spring having a first spring arm and a second spring arm sustained against the mouse main body and the storage body, respectively.

In an embodiment, the wireless mouse further comprises a power switch disposed within the mouse main body. A terminal of the wireless signal receiver touches the power switch when the storage device is in the first usage status.

In an embodiment, the wireless mouse further comprises a power switch and a switch touch piece disposed within the mouse main body. The switch touch piece touches the power switch when the storage device is in the first usage status.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded diagram of a wireless mouse according to a first embodiment of the present invention;

FIG. 2 schematically illustrates the wireless mouse of FIG. 1 in a first usage status;

FIG. 3 schematically illustrates the wireless mouse of FIG. 1 in a second usage status;

FIG. 4 is a schematic exploded diagram of a wireless mouse according to a second embodiment of the present invention;

FIG. 5 schematically illustrates the wireless mouse of FIG. 4 in a first usage status;

FIG. 6 schematically illustrates the wireless mouse of FIG. 4 in a second usage status; and

FIG. 7 is a schematic diagram illustrating that the power switch of the wireless mouse of FIG. 4 is turned on when the switch touch piece is allowed to touch the power switch.

### DETAILED DESCRIPTION OF THE PREFERRED EMBODIMENT

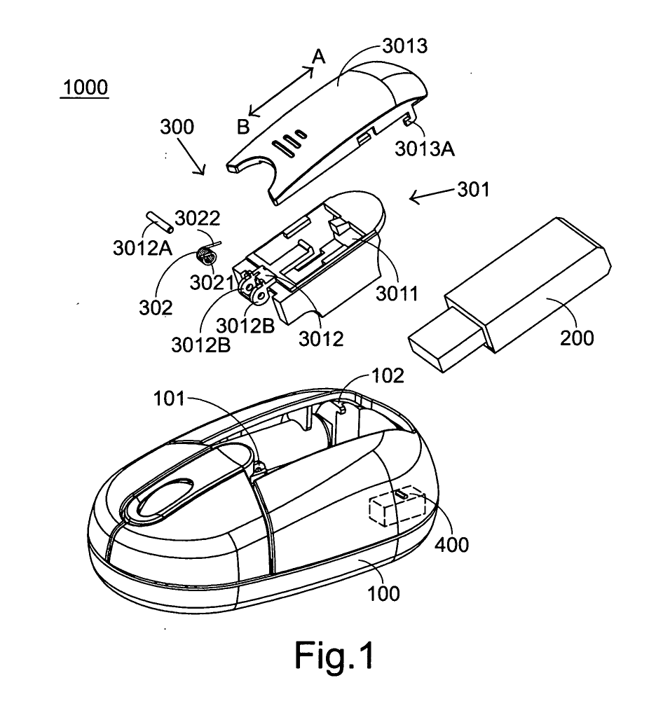

Referring to FIG. 1, a schematic exploded diagram of a wireless mouse according to a first embodiment of the present invention is shown. The wireless mouse 1000 of FIG. 1 comprises a mouse main body 100, a wireless signal receiver 200 and a storage device 300. The storage device 300 comprises a storage body 301 and a resilience element 302. In this embodiment, the resilience element 302 is a torsion spring having a first spring arm 3021 and a second spring arm 3022. The storage body 301 comprises a storage part 3011, a first connecting part 3012, a pivot shaft 3012A and a sliding sheet 3013. The sliding sheet 3013 has a fastening element 3013A. The first connecting part 3012 comprises two tabs 3012B with connecting holes. In addition, there is a second connecting part 101, a fastening part 102 and a power switch 400 within the mouse main body 100.

The operating functions of the wireless mouse in FIG. 1 will be illustrated in details as follows. For assembling the storage device 300, the sliding sheet 3013 is moved in a linear direction A-B relative to the storage body 301 so as to be engaged with the storage body 301. The spiral portion of the torsion spring 302 is arranged between the two tabs 3012B of the first connecting part 3012. Then, the pivot shaft 3012A penetrates through the connecting holes of the two tabs 3012B, the connecting holes of the second connecting part 101 within the mouse main body 100 and the perforation formed in the spiral portion of the torsion spring 302. In such manner, the storage body 301 is pivotally coupled to the mouse main body 100.

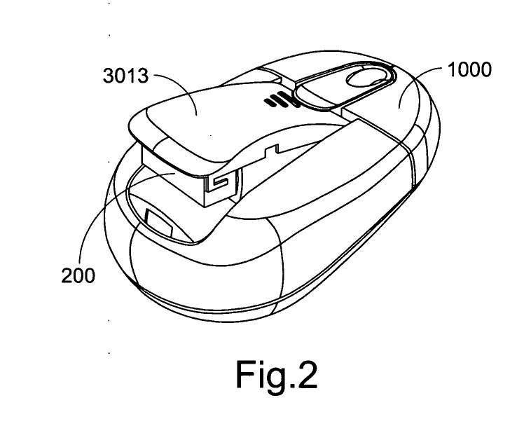

As shown in FIG. 2, once the storage body 301 is pivotally coupled to the mouse main body 100, the first spring arm 3021 of the torsion spring 302 is sustained within the mouse main body 100. Whereas, the second spring arm 3022 of the torsion spring 302 is sustained against the storage body 301. Due to a torsional force resulting from the torsion spring 302, the storage body 301 can be uplifted from the mouse main body 100, thereby exposing the storage part 3011 thereof.

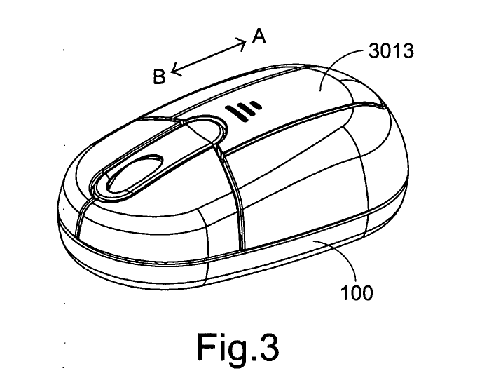

Under this circumstance, the wireless signal receiver 200 can be placed within the storage part 3011 of the storage device 300. After the storage device 300 is pressed down such that the fastening element 3013A of the sliding sheet 3013 is engaged with the fastening part 102 within the mouse main body 100, the storage device 300 is stored within the mouse main body 100 accordingly, as can be seen in FIG. 3. In a case that the wireless signal receiver 200 is stored in the storage device 300 and the storage device 300 is stored in the mouse main body 100, the wireless mouse is not in use. Under this circumstance, a terminal of the wireless signal receiver 200 touches the power switch 400 to power off the wireless mouse, thereby saving power consumption.

Please refer to FIG. 3 again. When the wireless mouse is to be operated, the sliding sheet 3013 is moved toward the rear end of the mouse main body 100 in the arrow direction A. Meanwhile, the fastening element 3013A of the sliding sheet 3013 will be disengaged from the fastening part 102 within the mouse main body 100. In response to the torsional force resulting from the torsion spring 302, the storage body 301 will be uplifted from the mouse main body 100, thereby exposing the storage part 3011 thereof, as is shown in FIG. 2. Under this circumstance, the wireless signal receiver 200 can be removed from the storage device 300. Subsequently, the storage device 300 is pressed down and the sliding sheet 3013 is moved toward the front end of the mouse main body 100 in the arrow direction B such that the fastening element 3013A of the sliding sheet 3013 is engaged with the fastening part 102 within the mouse main body 100. In such manner, the storage device 300 is stored within the mouse main body 100 accordingly. Under this circumstance, since the wireless signal receiver 200 is detached from the storage part 3011 of the storage body 301, the terminal of the wireless signal receiver 200 no longer touches the power switch 400, and thus the wireless mouse is maintained in the power-on state.

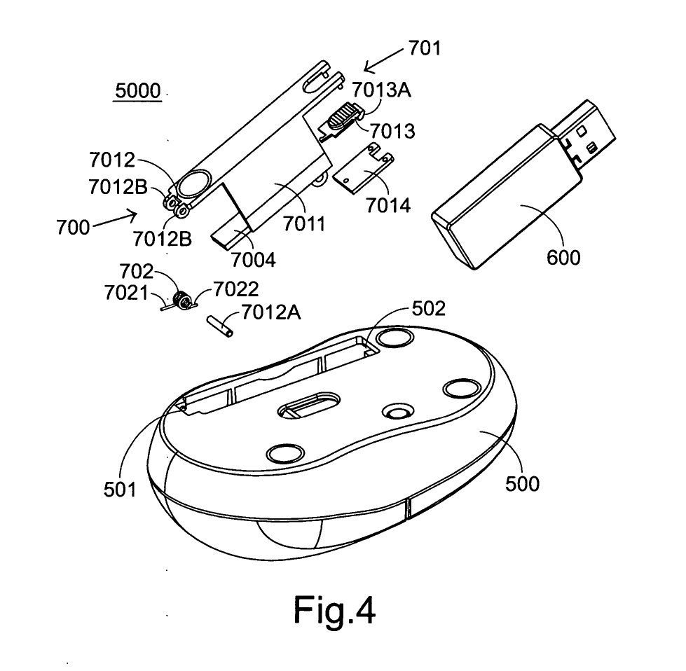

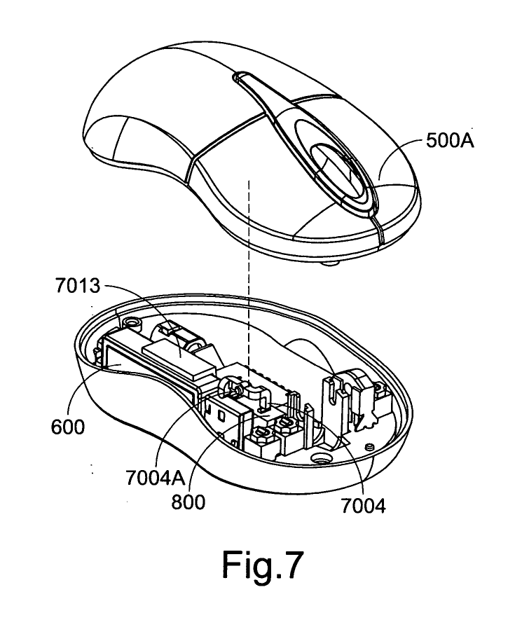

Referring to FIG. 4, a schematic exploded diagram of a wireless mouse according to a second embodiment of the present invention is shown. The wireless mouse 5000 of FIG. 4 comprises a mouse main body 500, a wireless signal receiver 600 and a storage device 700. The storage device 700 comprises a storage body 701 and a resilience element 702. In this embodiment, the resilience element 702 is also a torsion spring having a first spring arm 7021 and a second spring arm 7022. The storage body 701 comprises a storage part 7011, a first connecting part 7012, a pivot shaft 7012A, a sliding sheet 7013 and a sliding sheet fixing member 7014. The sliding sheet 7013 has a fastening element 7013A. The first connecting part 7012 comprises two tabs 7012B with connecting holes. In addition, there is a second connecting part 501, a fastening part 502 and a power switch 800 within the mouse main body 500 (as shown in FIG. 7).

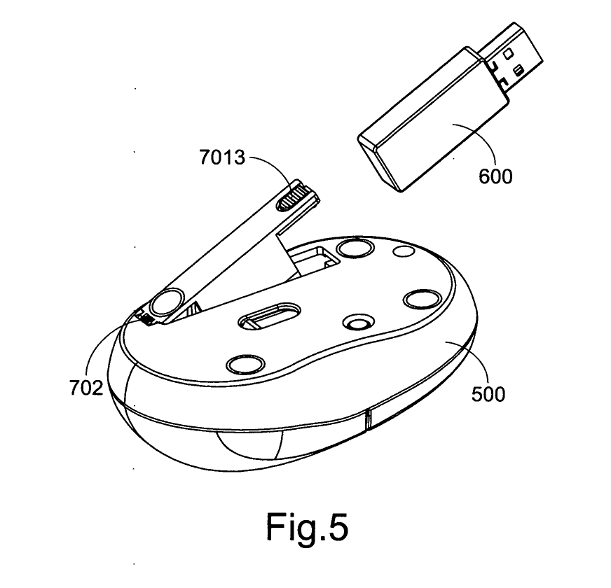

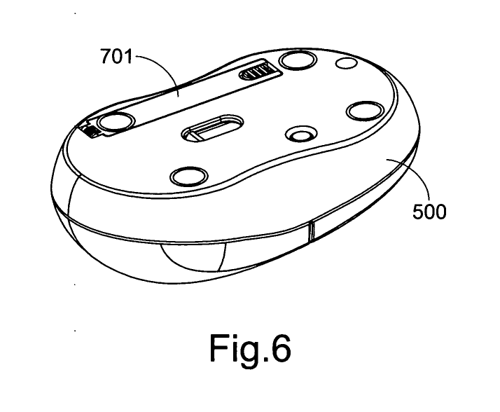

As shown in FIG. 5, the storage device 700 of FIG. 4 is pivotally coupled to the mouse main body 500 but is not stored within the mouse main body 500. In contrast, FIG. 6 schematically illustrates that the storage device 700 of FIG. 4 has been stored within the mouse main body 500.

In the embodiment of FIG. 4, the constituent components included therein are similar to those shown in FIG. 1, and are not to be redundantly described herein. The main difference between these embodiments is the location of the storage device. The storage device of FIG. 1 is disposed at the front side of the mouse main body. Whereas, the storage device of FIG. 4 is disposed at the back side of the mouse main body. Furthermore, the touching means of the power switches of theses two embodiments are distinguished.

Referring to FIG. 7, a switch touch piece 7004 of the wireless switch according to the second embodiment is shown. The switch touch piece 7004 is conventionally fixed on the top cover 500A of the mouse main body 500, and comprises a rotating shaft 7004A. In a case that no external force is applied on the switch touch piece 7004, the switch touch piece 7004 is freely rotated with the rotating shaft 7004A serving as a fulcrum. Once the wireless signal receiver 600 is stored within the storage part 7011 of the storage device 700, a terminal of the wireless signal receiver 600 will be sustained against one end of the switch touch piece 7004. Under this circumstance, the other end of the switch touch piece 7004 will touch the power switch 800, and thus the power switch 800 is turned off. On the other hand, if the wireless signal receiver 600 is removed from the storage part 7011 in order to be operated, the wireless signal receiver 600 is no longer sustained against the switch touch piece 7004. Meanwhile, the switch touch piece 7004 fails to touch the power switch 800, and thus the power switch 800 is turned on.

From the above description, the storage space of the storage device will be exposed to the user when the sliding sheet is moved toward the rear end of the mouse main body, thereby facilitating removing or inserting the wireless signal receiver. Whereas, when the storage device is pressed down and the sliding sheet is moved toward the front end of the mouse main body, the storage device can be stored within the mouse main body. Therefore, the storage device of the wireless mouse is advantageous for storing the wireless signal receiver.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless mouse comprising:
a mouse main body for generating a pointing signal to control a pointer of a computer;
a wireless signal receiver in communication with the computer for receiving said pointing signal and transmitting said pointing signal to said computer; and
a storage device disposed within said mouse main body for storing said wireless signal receiver, and comprising a storage body and a resilience element, wherein said storage body comprises a storage part for containing said wireless signal receiver, a first connecting part for allowing said storage body to be pivotally coupled to said mouse main body, and a sliding sheet moving relative to said storage part and having a fastening element for allowing said storage body to be engaged within said mouse main body therevia when said storage device is in a first usage status, wherein said resilience element is disposed on said first connecting part for providing an elastic force to said storage body such that said storage body is disengaged from inside of said mouse main body when said storage device is in a second usage status.

2. The wireless mouse according to claim 1 wherein said resilience element is a torsion spring having a first spring arm and a second spring arm sustained against said mouse main body and said storage body, respectively.

3. The wireless mouse according to claim 1 further comprising a power switch disposed within said mouse main body, wherein a terminal of said wireless signal receiver touches said power switch when said storage device is in said first usage status.

4. The wireless mouse according to claim 1 further comprising a power switch and a switch touch piece disposed within said mouse main body, wherein said switch touch piece touches said power switch when said storage device is in said first usage status.
